(19) United States
(12) Patent Application Publication
(10) Pub. No.: US 2003/0041517 A1
(43) Pub. Date: Mar. 6, 2003

(54) Sleeve with concave lower end

(76) Inventors: Donald E. Weder, Highland, IL (US); Joseph G. Straeter, Highland, IL (US); Paul Fantz, Imperial, MO (US)

Correspondence Address: DUNLAP, CODDING & ROGERS P.C., PO BOX 16370, OKLAHOMA CITY, OK, 73114, US

(21) Appl. No.: 09/941,993

(22) Filed: Aug. 29, 2001

(51) Int. Cl. A01G 9/02

(52) U.S. Cl. 47/72

(57) ABSTRACT

A floral sleeve initially having a flattened state and openable therefrom for use in covering, containing or wrapping a floral grouping, botanical item, pot, or pot having a floral grouping or botanical item therein. The sleeve has a concave lower end having an inwardly curved lower edge, and may have a detachable upper portion. The sleeve may have a non-linear or linear upper edge. when having a detachable upper portion, the sleeve has a detaching element which, when employed to detach the upper portion, leaves a linear or non-linear upper edge on the lower portion of the sleeve. The concave lower end of the sleeve may have a gusset therein.

### RELATED REFERENCES

Not applicable.

### FIELD OF THE INVENTION

This invention generally relates to sleeves, and more particularly, to sleeves used to wrap floral groupings or flower pots containing floral groupings and/or mediums containing floral groupings, and methods of using same. U.S. Pat. Nos. 5,625,979 and 5,493,809 and pending U.S. Ser. No. 09/189,033 disclose subject matter which may be relevant to the invention contemplated and claimed herein and each is hereby expressly incorporated herein by reference in its entirety.

### BRIEF DESCRIPTION OF THE DRAWINGS

FIG. 1 is an elevational view of a sleeve constructed in accordance with the present invention.

FIG. 2 is a cross-sectional view of the sleeve of FIG. 1 taken along line 2-2 thereof.

FIG. 3 is a perspective view of the sleeve of FIG. 1 having a floral grouping therein.

FIG. 4 is a perspective view of the sleeve of FIG. 1 having a pot and floral grouping therein.

FIG. 5 is an elevational view of another embodiment of a sleeve constructed in accordance with the present invention.

FIG. 6 is a cross-sectional view of the sleeve of FIG. 5 taken along line 6-6 thereof.

FIG. 7 is an elevational view of another embodiment of a sleeve constructed in accordance with the present invention.

FIG. 8 is an elevational view of another embodiment of a sleeve constructed in accordance with the present invention.

FIG. 9 is an elevational view of another embodiment of a sleeve constructed in accordance with the present invention.

FIG. 10 is an elevational view of another embodiment of a sleeve constructed in accordance with the present invention.

### DESCRIPTION OF THE PREFERRED EMBODIMENTS

The present invention contemplates in a preferred version a preformed sleeve (also referred to herein as a “floral sleeve” or a “sleeve”) having a tubular shape sized to contain and generally conform to a flower pot having an upper end, a lower end and an outer peripheral surface. The sleeve may further comprise a lower portion and a detachable upper portion which may be sized to surround and encompass a floral grouping.

The sleeve may form part of a plant package when used in conjunction with a floral grouping or a pot having a floral grouping therein, and wherein the pot and/or floral grouping are substantially surrounded and encompassed by the sleeve. The floral grouping is at least partially surrounded and encompassed and may be entirely enclosed by the upper portion when it forms a part of the preformed sleeve.

The sleeve may have a bonding material disposed on an inner portion thereof for bondingly connecting the sleeve to a pot disposed therein. Alternatively, the bonding material may be disposed on an outer portion of the sleeve for forming a plurality of crimps in a portion of the sleeve.

The lower portion of the sleeve may be constructed from a first material and the upper portion (when present) may be constructed from the first material or a second material different from the first material.

These embodiments and others of the present invention are now described in more detail below. It will be appreciated that the examples provided herein are not intended to limit the scope and extent of the claimed invention but are only intended to exemplify various embodiments of the invention contemplated herein.

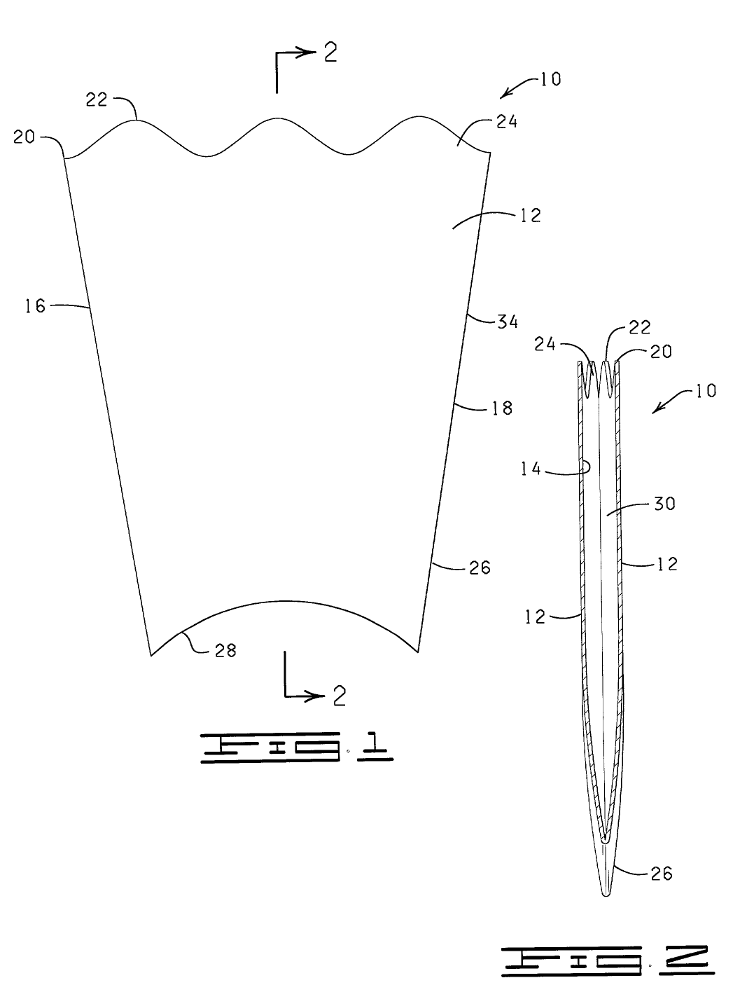

Shown in FIGS. 1-4 is a sleeve designated by the general reference numeral 10. The sleeve 10 has an outer peripheral surface 12, an inner peripheral surface 14, an upper end 20 having an upper edge 22, a skirt portion 24, and an inner space 30. The sleeve 10, in a flattened state, also includes a first sidewall edge 16, a second sidewall edge 18, and a concave lower end 26 having an inwardly curved lower edge 28.

The sleeve 10 is initially formed to have a flattened state and is openable therefrom to an open state for containing a floral container, such as a pot as described elsewhere herein. The shape of the concave lower end 26 may be elliptical, rounded, curvilinear, ovoid, or any other curved shape known in the art, but must be inwardly curved. The sleeve 10 is preferably individually sized so that a standard sized flower pot, such as a 3-inch, 3½-inch, 4-inch, 4½-inch, 5-inch, 5½-inch, 6-inch, 6½-inch, 7-inch or 8-inch pot, for example, can fit within the sleeve 10, with the pot preferably substantially conforming to the inner peripheral surface 14 of the sleeve 10. While the sleeve 10 preferably has a tapered, frusto-conical shape, the sleeve 10 may also have a rectangular or cylindrical shape.

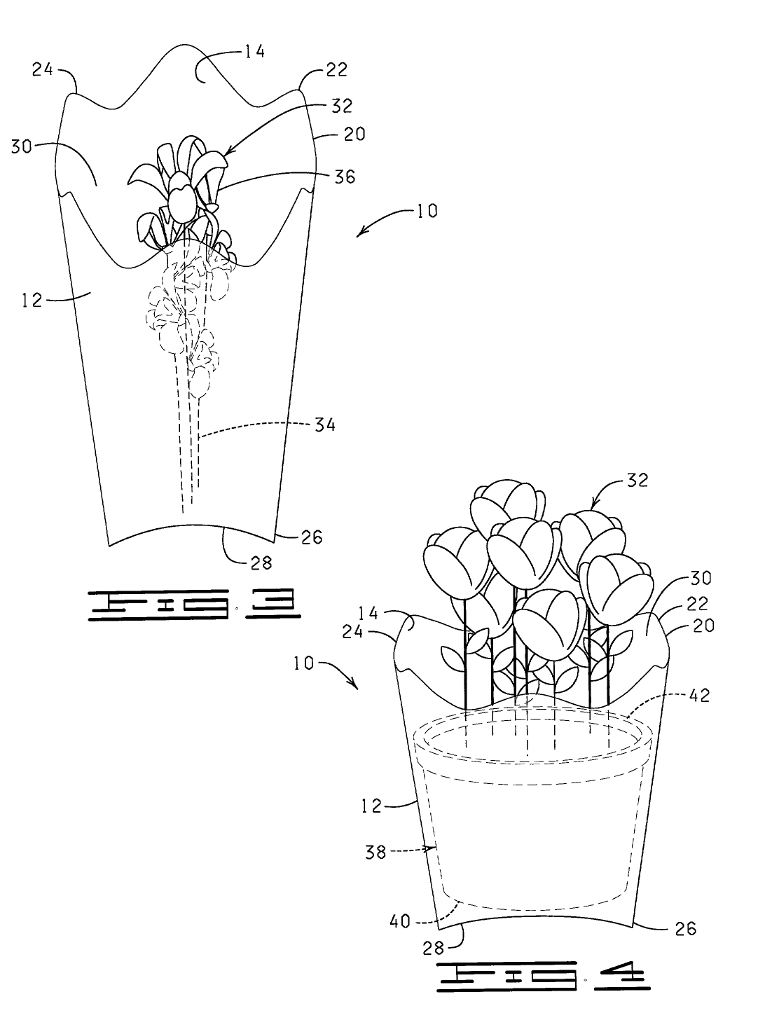

In a preferred version of the invention shown in FIGS. 1-4, the upper edge 22 of the upper end 20 of the sleeve 10 has a non-linear pattern such as a curve, wave, arc or serration. The upper edge 22 and the upper end 20 form the skirt portion 24 of the sleeve 10 for decorating a floral grouping 32. The floral grouping 32 has a stem portion 34 and a bloom portion 36 disposed in the sleeve 10 (FIG. 3). The floral grouping 32 may be disposed in a pot 38 having a lower end 40 and an upper end 42 which is disposed within the sleeve 10 (FIG. 4). Other non-linear configurations of the upper edge 22 of the skirt portion 24 will be readily apparent to one of ordinary skill in the art, for example, those shown in FIGS. 11-16 of U.S. Ser. No. 09/401,771, the entire specification of which is hereby expressly incorporated herein by reference.

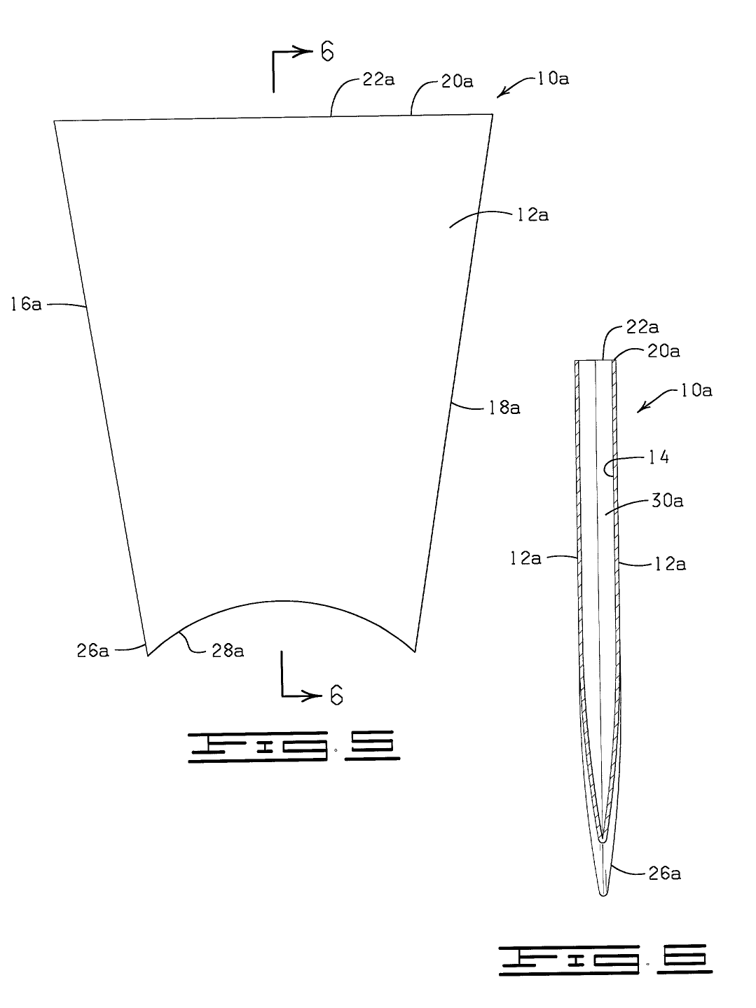

Shown in FIGS. 5-6 is a sleeve designated by the general reference numeral 10a. The sleeve la has an outer peripheral surface 12a, an inner peripheral surface 14a, an upper end 20a having an upper edge 22a, and an inner space 30a. The sleeve 10a, in a flattened state, also includes a first sidewall edge 16a, a second sidewall edge 18a, and a concave lower end 26a having an inwardly curved lower edge 28a. The shape of the concave lower end 26a may be elliptical, rounded, curvilinear, ovoid, or any other curved shape known in the art, but must be inwardly curved. The sleeve 10a differs from the sleeve 10 shown above primarily in that the upper edge 22a of the upper end 20a is linear rather than non-linear.

Shown in FIG. 7 is a sleeve designated by the general reference numeral 10b. The sleeve 10b has an outer peripheral surface 12b, an inner peripheral surface (not shown), an upper end 20b having an upper edge 22b, a skirt portion 24b, and an inner space (also not shown). The sleeve 10b, in a flattened state, also includes a first sidewall edge 16b, a second sidewall edge 18b, and a concave lower end 26b having an inwardly curved lower edge 28b. The shape of the concave lower end 26b may be elliptical, rounded, curvilinear, ovoid, or any other curved shape known in the art, but must be inwardly curved.

The sleeve 10b is similar to the sleeves 10 and 10a shown in FIGS. 1-6, except sleeve 10b comprises both a lower portion 46 and an upper portion 44. The upper portion 44 is detachable from the lower portion 46 via a detaching element 48, such as perforations. The upper portion 44 is generally sized so that it can substantially surround and enclose a floral grouping, alone (not shown) or disposed within a pot disposed within the sleeve 10b (not shown). The upper portion 44 may have apertures 50 therein for enabling the sleeve 10b to be supported from a support device or assembly such as a wicket, in a manner well known to those of ordinary skill in the art.

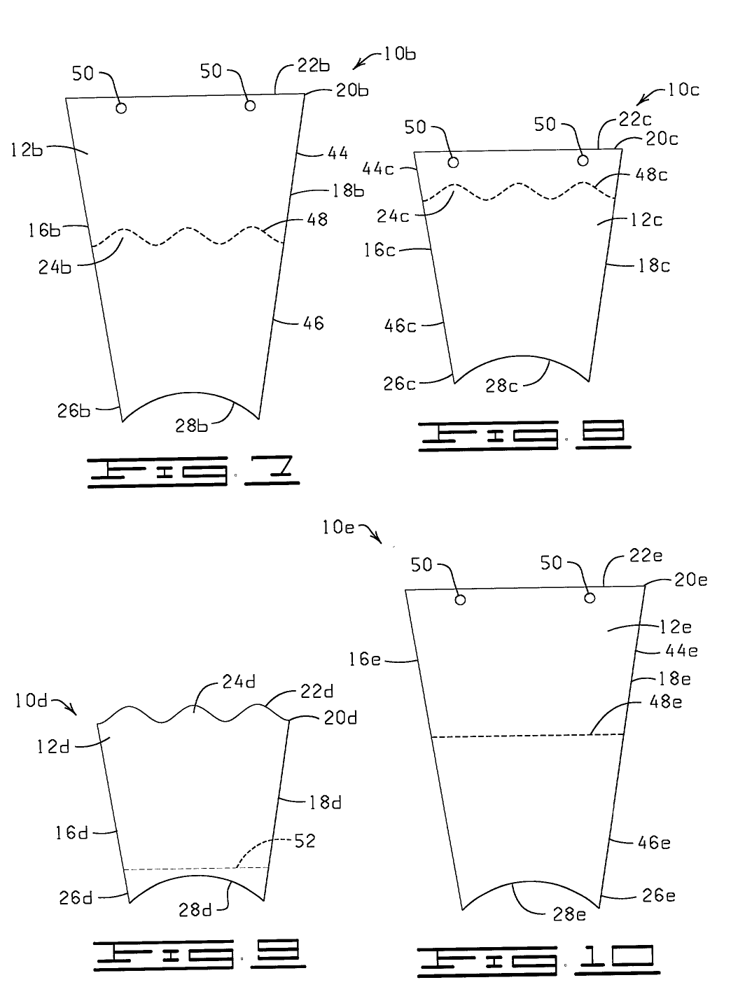

Shown in FIG. 8 is a sleeve designated by the general reference numeral 10c. The sleeve 10c has an outer peripheral surface 12c, an upper end 20c having an upper edge 22c, a skirt portion 24c, and an inner space (not shown). The sleeve 10c, in a flattened state, also includes a first sidewall edge 16c, a second sidewall edge 18c, and a concave lower end 26c having an inwardly curved lower edge 28c. The shape of the concave lower end 26c may be elliptical, rounded, curvilinear, ovoid, or any other curved shape known in the art, but must be inwardly curved.

Sleeve 10c is similar to sleeve 10b in having an upper portion 44c, a lower portion 46c, a detaching element 48c, and optionally, apertures 50, but differs in that the upper portion 44c is designed to be removed from the lower portion 46c before the lower portion 46c is used to cover a pot (not shown) or a floral grouping (not shown), and further, the upper portion 44c is generally not sized to enclose a floral grouping.

Shown in FIG. 9 is a sleeve designated by the general reference numeral 10d. The sleeve 10d has an outer peripheral surface 12d, an inner peripheral surface (not shown), an upper end 20d having an upper edge 22d, a skirt portion 24d, and an inner space (also not shown). The sleeve 10d, in a flattened state, also includes a first sidewall edge 16d, a second sidewall edge 18d, and a concave lower end 26d having an inwardly curved lower edge 28d. The shape of the concave lower end 26d may be elliptical, rounded, curvilinear, ovoid, or any other curved shape known in the art, but must be inwardly curved.

The sleeve 10d is similar to sleeve 10 described above, except sleeve 10d has a gusset 52 in the concave lower end 26d which enables the concave lower end 26d to be expanded when a floral grouping (not shown) or a pot (not shown) is disposed therein. Gussets, such as gusset 52, and their construction are well known to persons of ordinary skill in the art. Therefore, further discussion of these methods of construction is not deemed necessary herein.

Shown in FIG. 10 is a sleeve designated by the general reference numeral 10e. The sleeve 10e has an outer peripheral surface 12e, an inner peripheral surface (not shown), an upper end 20e having an upper edge 22e, and an inner space (also not shown). The sleeve 10e, in a flattened state, also includes a first sidewall edge 16e, a second sidewall edge 18e, and a concave lower end 26e having an inwardly curved lower edge 28e. The shape of the concave lower end 26e may be elliptical, rounded, curvilinear, ovoid, or any other curved shape known in the art, but must be inwardly curved.

The sleeve 10e is similar to the sleeve 10b in that sleeve 10e has an upper portion 44e, a lower portion 46e, a detaching element 48e, and may optionally have apertures 50. Sleeve 10e differs from sleeve 10b primarily in that the detaching element 48e has a linear or arcuate pattern which, when the sleeve 10e is in a flattened state, extends from the first sidewall edge 16e to the second sidewall edge 18e, rather than a non-linear pattern as shown for the detaching element 48 of sleeve 10b.

Any of the sleeves 10-10e contemplated herein may also be equipped with drainage elements (e.g., one or more holes) in the lower end thereof or ventilation holes (not shown), or can be made from permeable or impermeable materials.

Any thickness of material may be utilized in accordance with the present invention as long as the sleeves 10-10e may be formed as described herein, and as long as the sleeves 10-10e may contain at least a portion of a pot or floral grouping, as described herein. Additionally, an insulating material such as bubble film, preferably one of two or more layers, can be utilized in order to provide additional protection for the item, such as the floral grouping, contained therein.

The material from which the sleeves 10-10e described herein are constructed preferably has a thickness in a range from about 0.1 mil to about 30 mils. Often, the thicknesses of the sleeves are in a range from about 0.5 mil to about 10 mils or preferably, in a range from about 1.0 mil to about 5 mils. More preferably, the sleeves 10-10e are constructed from a material which is flexible, semi-rigid, rigid, or any combination thereof. The sleeves 10-10e may be constructed of a single layer of material or a plurality of layers of the same or different types of materials. The layers of material comprising the sleeves 10-10e may be connected together or laminated or may be separate layers. Such materials used to construct the sleeves 10-10e are described in U.S. Pat. No. 5,111,637, which is hereby expressly incorporated herein by reference.

The sleeves 10-10e are constructed from any suitable material that is capable of being formed into a sleeve and wrapped about a pot and a floral grouping (or a floral grouping alone) disposed therein. Preferably, the material comprises treated or untreated paper, metal foil, polymeric film, non-polymeric film, woven or non-woven fabric, or synthetic or natural fabric, cardboard, fiber, cloth, burlap, or laminations or combinations thereof.

In one embodiment, the sleeves 10-10e contemplated herein may be constructed from sheets comprising two polypropylene films which may be connected together or laminated or may be separate layers. In an alternative embodiment, the sleeves 10-10e may be constructed from only one sheet of the polypropylene film.

The term “polymeric film” means a synthetic polymer such as a polypropylene or a naturally occurring polymer such as cellophane. A polymeric film is relatively strong and not as subject to tearing (substantially non-tearable), as might be the case with paper or foil.

The materials comprising the sleeves 10-10e may vary in color and, as described herein, may consist of designs or decorative patterns which are printed, etched, and/or embossed thereon using inks or other printing materials. An example of an ink which may be applied to the surface of the material is described in U.S. Pat. No. 5,147,706, which is hereby expressly incorporated herein by reference.

In addition, the material may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination. Moreover, portions of the material used in constructing the sleeves 10-10e may vary in the combination of such characteristics. The material utilized for the sleeves 10-10e may be opaque, translucent, transparent, or partially clear or tinted transparent.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. As noted earlier, the floral grouping comprises a bloom portion and a stem portion. Further, the floral grouping may comprise a growing potted plant having a root portion (not shown). However, it will be appreciated that the floral grouping may consist of only a single bloom or only foliage, or a botanical item, or a propagule. The term “floral grouping” may be used interchangeably herein with both the terms “floral arrangement” and “potted plant”. The term “potted plant” generally refers to a floral grouping and a pot along with a growing medium. The term “floral grouping” may also be used interchangeably herein with the terms “botanical item” and/or “propagule”.

The term “growing medium” when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as a bouquet or a floral grouping.

The term “propagule” when used herein means any structure capable of being propagated or acting as an agent of reproduction including seeds, shoots, stems, runners, tubers, plants, leaves, roots, or spores.

In accordance with the present invention a bonding material (not shown) may optionally be disposed on a portion of any of the sleeves 10-10e described herein, or provided separately, to attach each sleeve 10-10e to a pot having a floral grouping therein and disposed within the sleeve 10-10e. The bonding material may alternatively be a band, tie, string, ribbon, wire, tape, heat shrinkable material or other tying or banding device which may be constructed within or attached to the sleeve 10-10e before it is applied about the pot or floral grouping or may be provided only after the sleeve 10-10e is applied about the pot or floral grouping. A separate bonding material may also assist in closing or sealing the upper portion (when present) of the sleeve 10-10e or in adhering the sleeve 10-10e to the pot after the pot has been disposed therein. Examples of how a bonding material may be disposed on the sleeve are shown in U.S. Pat. Nos. 5,493,809 and 5,625,979, both of which are hereby expressly incorporated herein by reference in their entirety.

The term “detaching element” when used generally herein, means any element or device such as, but not limited to, perforations, tear strips, zippers, and any other devices or elements of this nature known in the art, or any combination thereof, which enable the tearing away or detachment of one object from another. Therefore, while perforations are shown and described in detail herein, it will be understood that tear strips, zippers, or any other “detaching element” known in the art, or any combination thereof, could be substituted therefore and/or used therewith.

Each of the upper portions 44, 44c or 44e of the sleeves 10b, 10c and 10e, respectively, may also have an additional substantial vertically disposed detaching element comprising a plurality of vertical perforations (not shown but well known in the art) for facilitating removal of the upper portion 44, 44c or 44e from the lower portion 46, 46c or 46e, respectively.

As indicated above, it will be understood by a person of ordinary skill in the art that equipment and devices for forming floral sleeves are commercially available, and are well known to a person of ordinary skill in the art. Further detailed discussion of the construction of the sleeves described herein therefore is not deemed necessary. However, briefly, the sleeves described herein may be formed by intermittently advancing two separate webs, one or two webs preformed in the form of a tube, or a single web folded double and sealing the longitudinal sides and bottom portions of the two facing panels then cutting the sleeve thus formed from the webs or web. Machines which can form sleeves from such single webs or pairs of webs are well within the knowledge of one of ordinary skill in the art.

As noted above, any of the sleeves 10-10e contemplated herein may have a lower end 26-26e, respectively, which is open or closed. When the lower end 26-26e is closed, the lower end 26-26e may have one or more gussets 52, as described elsewhere herein, formed therein for allowing expansion of the lower end 26-26e when an object with a broad lower end, such as a pot, is disposed therein. In another version, the sleeve 10-10e may include a flap (not shown) which can be folded over and sealed with a bonding material to close the sleeve 10-10e.

The term “pot” or “flower pot,” as used herein, refers to any type of container used for holding a floral grouping or plant, including vases. Examples of pots, used in accordance with the present invention include, but not by way of limitation, clay pots, wooden pots, plastic pots, foam pots, pots made from natural and/or synthetic fibers, and/or any combination thereof. The pot is adapted to receive a floral grouping in a retaining space thereof. The floral grouping may be disposed within the pot along with a suitable growing medium described elsewhere herein, or other retaining medium, such as a floral foam. It will also be understood that the floral grouping, and any appropriate growing medium or other retaining medium, may be disposed in the sleeve without a pot for cultivating the floral grouping or displaying a grown floral grouping or botanical item.

It should also be noted that for all versions of sleeves described above which have a bonding material thereon, it may be desirable to have a release material or cover strip covering the adhesive or cohesive bonding material disposed on any portion of such sleeves for preventing the bonding material from bonding to another surface until such is desired. Further, in each of the cases described herein wherein a sleeve is applied to a pot, the sleeve may be applied thereto either by depositing the pot downwardly into the opened sleeve, or the sleeve may be brought upwardly about the pot from below the pot.

It should be further noted that various features of the versions of the present invention such as closure bonding areas, support apertures, handles or handle apertures, additional perforations, drainage elements, ventilation holes, combinations of material may be used alone or in combination as elements of any of the embodiments described above herein.

Changes may be made in the construction and the operation of the various components, elements and assemblies described herein or in the steps or the sequence of steps of the methods described herein without departing from the spirit and scope of the invention as defined in the following claims.

What is claimed is:

1. A sleeve having a flattened state and openable therefrom to an opened state and, in the flattened state, comprising an outer peripheral surface, an inner peripheral surface, a first sidewall edge, a second sidewall edge, an upper end having an upper edge, and a concave lower end having an inwardly curved lower edge, and the sleeve further comprising an inner space in the opened state.

2. The sleeve of claim 1 wherein the concave lower end has a shape which is elliptical, curvilinear, rounded or ovoid.

3. The sleeve of claim 1 further comprising a gusset in the concave lower end.

4. The sleeve of claim 1 further comprising a detaching element for enabling detachment of an upper portion of the sleeve from a lower portion of the sleeve.

5. The sleeve of claim 4 wherein the detaching element comprises perforations.

6. The sleeve of claim 4 wherein the detaching element has a non-linear pattern such that when the upper portion is detached, the lower portion is left with an upper end having a non-linear upper edge.

7. The sleeve of claim 4 wherein the detaching element has a linear pattern such that when the upper portion is detached, the lower portion is left with an upper end having a linear upper edge.

8. The sleeve of claim 4 wherein the upper portion is sized to substantially surround and enclose a floral grouping.

9. The sleeve of claim 4 wherein the upper portion is adapted to support the sleeve from a support element.

10. The sleeve of claim 1 further comprising a skirt portion.

11. The sleeve of claim 1 wherein the sleeve has a generally frusto-conical shape when in the opened state.

12. The sleeve of claim 1 wherein the upper edge of the upper end is non-linear.

13. The sleeve of claim 1 wherein the upper edge of the upper end is linear.

14. A sleeve having a flattened state and openable therefrom to an opened state and, in the flattened state, comprising:
an outer peripheral surface, an inner peripheral surface, a first sidewall edge, a second sidewall edge, an upper end having an upper edge, and a concave lower end having an inwardly curved lower edge, and the sleeve further comprising an inner space in the opened state; and
a detaching element extending from the first sidewall edge to the second sidewall edge for detaching an upper portion of the sleeve from a lower portion of the sleeve.

15. The sleeve of claim 14 wherein the concave lower end has a shape which is elliptical, curvilinear, rounded or ovoid.

16. The sleeve of claim 14 further comprising a gusset in the concave lower end.

17. The sleeve of claim 14 wherein the detaching element comprises perforations.

18. The sleeve of claim 14 wherein the detaching element has a non-linear pattern such that when the upper portion is detached, the lower portion is left with an upper end having a non-linear upper edge.

19. The sleeve of claim 14 wherein the detaching element has a linear pattern such that when the upper portion is detached, the lower portion is left with an upper end having a linear upper edge.

20. The sleeve of claim 14 wherein the upper portion is sized to substantially surround and enclose a floral grouping.

21. The sleeve of claim 14 wherein the upper portion is adapted to support the sleeve from a support element.

22. The sleeve of claim 14 further comprising a skirt portion.

23. The sleeve of claim 11 wherein the sleeve has a generally frusto-conical shape when in the opened state.
